(19) United States
(12) Patent Application Publication
(10) Pub. No.: US 2007/0136613 A1
(43) Pub. Date: Jun. 14, 2007

(54) POWER SUPPLY SYSTEM

(75) Inventor: Chun-Hung Chen, TAIPEI (TW)

Correspondence Address: D-WAY SCIENTIFIC CO., LTD, 2F-4. NO. 148, SEC. 4, CHUNG HSIAO E. ROAD, TAIPEI, TW

(73) Assignee: D-WAV SCIENTIFIC CO., LTD., Jubei City (TW)

(21) Appl. No.: 11/306,042

(22) Filed: Dec. 14, 2005

(51) Int. Cl. G06F 1/00

(52) U.S. Cl. 713/300

(57) ABSTRACT

A power supply system is disclosed to include a fuel cell, and a base member, which has a receptacle type connection interface for receiving the fuel cell, a plurality of powered USB connectors for receiving different electronic apparatus and providing different voltages to the connected electronic apparatus, and a powered USB hub electrically connected between the connection interface and the powered USB connectors for controlling supply of different voltages from the fuel cell to the powered USB connectors and transmission of signal among the electronic apparatus being respectively connected to the powered USB connectors.

### BACKGROUND OF THE INVENTION

1. Field of the Invention

The present invention relates to a power supply system and more particularly, to such a power supply system, which uses a fuel cell to provide power, powered USB connectors to receive and link PC and computer peripheral apparatus, and a powered USB hub to control supply of different voltages from the fuel cell to the powered USB connectors and signal transmission among the connected PC and computer peripheral apparatus.

2. Description of the Related Art

Following fast development of electronic technology, a variety of advanced high-tech electronic devices have been continuously developed to improve our living. We can see different electronic devices around our surroundings. Nowadays, a computer has become one of the requisite products to many people. We may use computer at home, in office, or other places to handle different works, to make trades, to search information and data. It is the market tendency to develop computers having light, thin, short and small characteristics.

The signal transmission between a computer and a peripheral apparatus can be done through a cable or in a wireless manner. For a wired connection between a computer and a peripheral apparatus, a cable shall be used. Different cables with different connectors may be used for the connection of different peripheral apparatus to different computers. These connectors include powered USB connectors, USB connectors, PS2 connectors, RJ connectors, AV connectors, COM connectors, LPT connectors, and etc. USB connectors are mostly commonly used for the connection between a computer and computer peripheral apparatus such printer, CD/DVD/COMBO, scanner, modem/router, and etc. When a number of different computer peripheral apparatus are connected to a computer, different powered cables shall also be used to connect these computer peripheral apparatus to power supply. Further, a computer and computer peripheral apparatus may require different working voltages. An interruption of power supply during working of the computer and the computer peripheral apparatus may result in a loss of data. Therefore, the supply of power is important.

In order to prevent interruption of power supply, various UPS (Uninterrupted Power Supply) systems and USB hubs are developed for the connection of different computer peripheral apparatus to a computer.

However, these various conventional designs are still not satisfactory in function because of the following drawbacks.

1. A UPS system provides power for only a limited period (1, 2 or 3 hours), not workable for a long period (several tens of hours), and therefore the application is limited.

When encountered a long period power failure due to a natural disaster or other unexpected situations, a UPS system cannot be charged to provide power to a computer and other computer peripheral apparatus. In this case, the UPS system becomes useless.

2. A computer and the related peripheral apparatus cannot be used in a remote place where city power supply is not available (remote mountain side, wild island, wild field, jungles, etc.) for a long period because the attached battery power can only support working for a limited period.

3. City power supply must be converted into DC power supply before providing to a computer and the related peripheral apparatus. During conversion of city power supply to DC power supply or UPS DC power supply to AC power supply, a power loss is inevitable.

4. A USB hub is connectable to a computer to obtain power and data from the computer. A USB hub provides only power of voltage 5V and current 500 mA, i.e., 2.5W. For a peripheral apparatus that consumes a high power must obtain use an external power supply.

Therefore, it is desirable to provide a power supply system that eliminates the aforesaid drawbacks.

### SUMMARY OF THE INVENTION

The present invention has been accomplished under the circumstances in view. According to one aspect of the present invention, the power supply system comprises a power supply unit formed of a fuel cell, and a base member, which has a receptacle type connection interface for receiving the fuel cell, a plurality of jacks for receiving different electronic apparatus and providing different voltages to the connected electronic apparatus, and a powered USB hub electrically connected between the connection interface and the jacks for controlling supply of different voltages from the fuel cell to the jacks and transmission of signal among the electronic apparatus being respectively connected to the jacks.

According to another aspect of the present invention, the jacks can be powered USB connectors, and different powered USB cables with the different USB connectors and different foolproof devices are selectively used to connect a PC/notebook computer and different peripheral apparatus to the powered USB connectors subject to respective voltage levels. The foolproof devices prevent an installation error that may cause damage to the powered USB connectors or the peripheral apparatus.

According to still another aspect of the present invention, the power supply unit can be formed of a fuel cell, a bio-cell and a nuclear cell, and the fuel cell includes PEMFC or PEFC (Proton Exchange Membrane Fuel Cell), AFC (Alkaline Fuel Cell), PAFC (Phosphoric Acid Fuel Cell), or DMFC (Direct Methanol Fuel Cell).

According to still another aspect of the present invention, a fuel supplier is provided for supplying a fuel to the fuel cell of the power supply unit. The fuel supplier has a supply tube connectable to the fuel cell.

### BRIEF DESCRIPTION OF THE DRAWINGS

FIG. 1 is an elevational view of a power supply system according to the present invention.

FIG. 2 is an exploded view of the power supply system according to the present invention.

FIG. 3 is a system block diagram of the power supply system according to the present invention.

FIG. 4A is a plain view of a powered USB cable for use with the power supply system according to the present invention.

FIG. 4B is a plain view of another powered USB cable for use with the power supply system according to the present invention.

FIG. 4C is a plain view of still another powered USB cable for use with the power supply system according to the present invention.

FIG. 4D is a plain view of still another powered USB cable for use with the power supply system according to the present invention.

FIG. 5 is an elevational view of an alternate form of the power supply system according to the present invention.

FIG. 6 is an elevational view of another alternate form of the power supply system according to the present invention.

### DETAILED DESCRIPTION OF THE PREFERRED EMBODIMENT

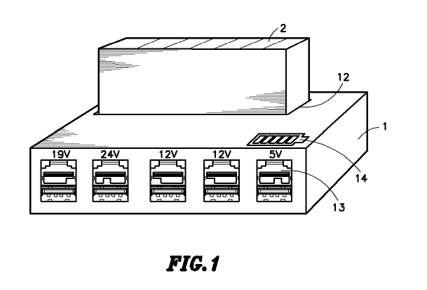

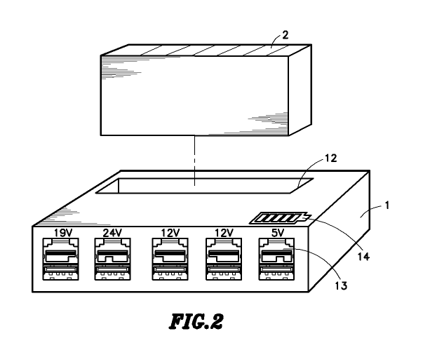

Referring to FIGS. 1 through 3, a power supply system in accordance with the present invention is shown comprised of a base member 1, and a power supply unit 2.

The base member 1 comprises an IC chip type control system, for example, a powered USB hub 11, an connection interface 12 electrically coupled to the control system (powered USB hub) 11 for receiving the power supply unit 2 and electrically connecting the power supply unit 2 to the control system (powered USB hub) 11, a plurality of jacks 13 provided at one side and respectively electrically coupled to the control system (power USB hub) 11, and a power meter 14 provided at the top side for power indication. According to this embodiment, the connection interface 12 is a receptacle.

The power supply unit 2 of the present invention is a fuel cell. By means of series or parallel circuit connection, the power supply unit 2 directly provides different DC voltages including 19V, 24V, 12V and 5V (5V for powered USB connector) without through an AC to DC power converting process.

The power supply unit 2 can be made in the form of a cartridge directly insertable into the connection interface 12 of the base member 1. During installation, the power supply unit 2 is inserted into the connection interface 12 of the base member 1 to provide different DC voltages to the jacks 13 subject to the control of the control system (powered USB hub) 11, enabling the jacks 13 to provide different voltages to external computer and different computer peripheral apparatus, for example, 12V˜19V for PC/notebook, 24V for printer, 12V for CD/DVD/Combo and scanner, 5V for modem/router. Because different voltages are directly provided from the jacks 13 to external electronic apparatus without transformer, power loss is eliminated. The jack 13 can be a powered USB connector that provides power supply and transmits signal.

According to the present invention, the jacks 13 can be powered USB connectors, USB connectors, IEEE1394 connectors, or RJ connectors.

When the power meter 14 of the base member 1 shows power low, the power supply unit 2 can be detached from the base member 1 for a replacement or filling of new supply of fuel. The power supply unit 2 is selected from a group of power supply means including fuel cells, bio-cells and nuclear cells, and the fuel cells include PEMFC or PEFC (Proton Exchange Membrane Fuel Cell), AFC (Alkaline Fuel Cell), PAFC (Phosphoric Acid Fuel Cell), or DMFC (Direct Methanol Fuel Cell). Basically, the structure of a fuel cell is similar to a regular battery, having an anode and a cathode and using an electrolyte to separate the anode from the cathode. However, unlike a regular battery, a fuel cell is an open system that continuously provides electricity by means of the continuous supply of a reactant. Many reactants can be used for this purpose. In a hydrogen fuel cell, hydrogen reacts with oxygen in the air to produce electrical energy directly. The chemical reaction that powers hydrogen fuel cells is the same as that which occurs when hydrogen burns. The chemical equation for this reaction is: 2H₂+O₂→2H₂O+energy. “Normally hydrogen burns, reacting with oxygen from the air, producing water, heat and light.” In the fuel cell the chemical reaction is exactly the same, but instead of producing light and heat energy, electrical energy is produced. When a fuel containing hydrogen is passed over the negative electrode (anode), it is ionized. Ionization of the fuel, often accomplished with the assistance of a catalyst, removes electrons from the hydrogen creating positively charged hydrogen ions and negatively charged free electrons. At this time, only the ions can pass through the electrolyte situated between the electrode, and the electrons must find another route to the positive electrode or cathode, where they will be reunited with the hydrogen ions and combined with oxygen atoms to form water. The electrons passing around the electrolyte constitute an electric current for use to provide power during their journey from anode to cathode.

A fuel cell produces DC power supply for computer and computer peripheral apparatus directly without through an AC to DC power conversion process.

Alternatively, a bio-cell can be used for the power supply unit 2 instead of a fuel cell.

Further, the battery pack of a notebook computer can only support working of the notebook computer for a limited period. A powered USB cable 3 can be used to connect the jacks 13 of the base member 1 to a notebook computer, enabling the notebook computer to obtain the necessary working voltage from the power supply unit 2. Therefore, the user can use the notebook computer with the power supply system of the present invention outdoors or at any location where power supply is not available without time limitation.

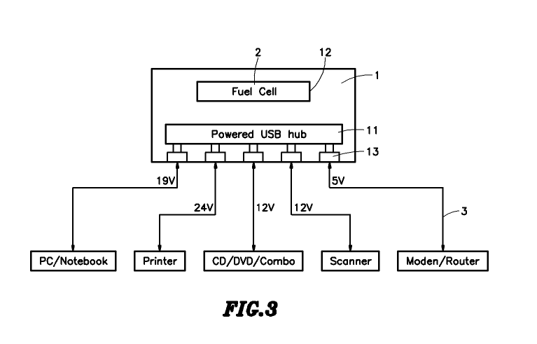

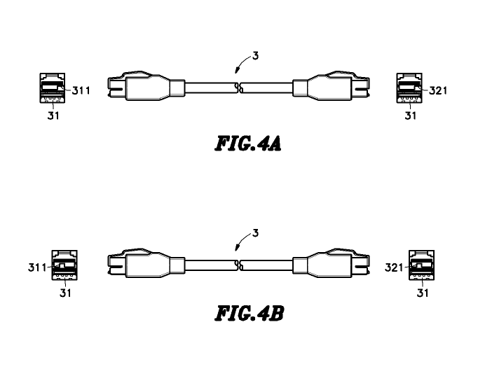

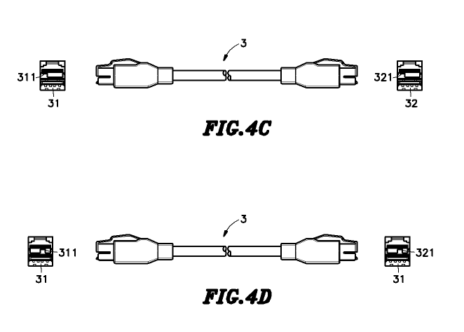

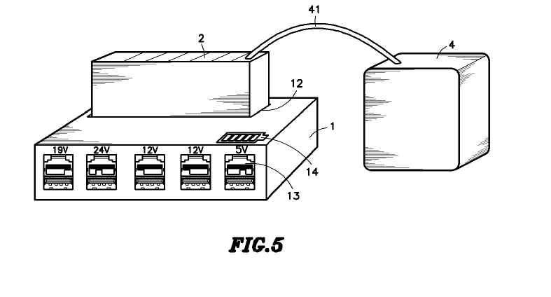

Referring to FIGS. 4A˜4D and FIG. 3 again, different powered USB cables 3 with different USB connectors 31 or 32 and different foolproof devices 311 or 321 may be selectively used to connect a PC/notebook computer and different peripheral apparatus to the jack 13 subject to respective voltage levels. The foolproof devices 311 and 321 prevent an installation error that may cause damage to the jacks 13 or the peripheral apparatus.

FIG. 5 shows an alternate form of the power supply system according to the present invention. According to this embodiment, a fuel supplier 4 is provided having a supply tube 41 connectable to the power supply unit 2. When the fuel of the power supply unit 2 is used up, the supply tube 41 of the fuel supplier 4 is connected to the power supply unit 2 to deliver the fuel to the power supply unit 2, enabling the power supply unit 2 to keep working and providing power.

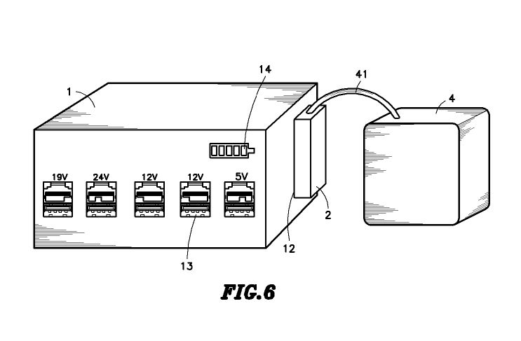

FIG. 6 shows another alternate form of the power supply system according to the present invention. According to this embodiment, the connection interface 12 of the base member 1 is provided at one lateral side for receiving the power supply unit 2, and the supply tube 41 of the fuel supplier 4 can be connected to the power supply unit 2 to supply the fuel. Frequent plugging and unplugging action of the power supply unit 2 may affect the connection performance between the base member 1 and the power supply unit 2. The use of the fuel supplier 4 eliminates this problem, and the power supply unit 2 can be constantly kept attached to the base member 1.

As indicated above, the invention provides a power supply system, which uses a power supply unit (fuel cell) 2 to provide power, and a base member 1 with a the control system 1I1 to control supply of different voltages to different jacks 13 by means of series or parallel circuit connection without the use of a voltage converter. The power supply unit 2 can be filled with new fuel and used repeatedly. The power supply system can be carried to any place where city power supply is not available or failed, and to provide the necessary working voltages to PC/notebook computer and different peripheral apparatus for a long period.

The power supply system of the present invention has the following advantages.

1. The power supply system uses a fuel cell to provide power for a long period (several tens of hours). Further, the fuel of the fuel cell can be replenished or changed, enabling the power supply system to continuously provide power to PC/notebook computer and different computer peripheral apparatus.

2. When city power failed for a long period, the power supply system can continuously provide power to PC/notebook computer and different computer peripheral apparatus for a long period.

3. The power supply system can be carried to a remote place where city power supply is not available (remote mountain side, wild island, wild field, jungles, etc.) to provide power to a PC/notebook computer and different computer peripheral apparatus for a long period.

4. The power supply system uses the fuel cell and the control system to provide different DC voltages for different electronic apparatus without through an AC to DC power converting process, and different peripheral apparatus can obtain the respective working voltages from the power supply system without through PC/notebook computer.

5. By means of series or parallel circuit connection, the power supply system provides different voltages (19V, 24V, 12V, 5V to different powered USB connectors at the base member, enabling different peripheral apparatus to be electrically connected to the PC/notebook computer while obtaining respective voltages from the power supply system.

A prototype of power supply system has been constructed with the features of FIGS. 1˜6. The power supply system functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A power supply system comprising:
a power supply unit; and
a base member, said base member comprising a connection interface adapted to receive said power supply unit, a plurality of powered USB connector for receiving different electronic apparatus and providing different voltages to the connected electronic apparatus, and a control system electrically connected between said connection interface and said powered USB connector for controlling supply of different voltages from said power supply unit to said powered USB connector and transmission of signal among the electronic apparatus being respectively connected to said powered USB connector.

2. The power supply system as claimed in claim 1, wherein said connection interface is a receptacle.

3. The power supply system as claimed in claim 1, wherein said control system is an IC chip.

4. The power supply system as claimed in claim 1, wherein said base member further comprises a power meter for power status indication.

5. The power supply system as claimed in claim 1, wherein said power supply unit is selected from a group of power supply means including fuel cells, bio-cells and nuclear cells.

6. The power supply system as claimed in claim 5, wherein said fuel cells include Proton Exchange Membrane Fuel Cells, Alkaline Fuel Cells, Phosphoric Acid Fuel Cells and Direct Methanol Fuel Cells.

7. The power supply system as claimed in claim 1, further comprising a fuel supplier for supplying a fuel to said power supply unit, said fuel supplier having a supply tube connectable to said power supply unit.
